(19) United States
(12) Patent Application Publication
(10) Pub. No.: US 2026/0030872 A1
(43) Pub. Date: Jan. 29, 2026

(54) METHOD AND APPARATUS FOR EXTRACTING FEATURE INFORMATION

(71) Applicant: Beijing Zitiao Network Technology Co., Ltd., Beijing (CN)

(72) Inventor: Li Zou, Beijing (CN)

(21) Appl. No.: 19/201,547

(22) Filed: May 7, 2025

(30) Foreign Application Priority Data
Jul. 24, 2024 (CN) 202411001155.7

(51) Int. Cl. G06V 10/77; G06V 10/764; G06V 10/94

(52) U.S. Cl. CPC G06V 10/7715; G06V 10/764; G06V 10/95

(57) ABSTRACT

An embodiment of the present application provides a method and apparatus for extracting feature information, which relates to the field of data processing technology. The method comprises: receiving a first operation input by a user to a terminal device, the first operation is used to trigger the terminal device to perform feature extraction on target material; in response to the first operation, sending configuration parameter request information to a server; receiving target configuration parameters sent by the server; and perform feature extraction on the target material based on the target configuration parameters to obtain feature information of the target material.

### CROSS-REFERENCE TO RELATED APPLICATION(S)

This application claims priority to Chinese Application No. 202411001155.7 filed Jul. 24, 2024, the disclosure of which is incorporated herein by reference in its entirety.

### FIELD

The present application relates to the field of data processing technology, and in particular to a method and apparatus for extracting feature information.

### BACKGROUND

When computers analyze and understand the content of visual material such as images and videos, the commonly used way is to extract features from the visual material and analyze and understand the visual material based on the extracted features. Therefore, feature extraction of the visual material is one of the key technologies for services such as image recommendation, video recommendation, and video search.

### SUMMARY

In view of this, an embodiment of the present application provides a method and apparatus for extracting feature information, which are used to solve the problem in the related art that the relevant configuration parameters (CP) of feature extraction cannot be flexibly updated.

In order to achieve the above purpose, the embodiments of the present application provide the following technical solutions:

In a first aspect, an embodiment of the present application provides a method for extracting feature information, comprising:
receiving a first operation input by a user to a terminal device, the first operation being used to trigger the terminal device to perform feature extraction on target material;
in response to the first operation, sending configuration parameter request information (CPRI) to the server;
receiving target configuration parameters sent by the server; and
performing the feature extraction on the target material based on the target configuration parameters to obtain feature information of the target material.

As an optional implementation of the embodiment of the present application, before sending the configuration parameter request information to the server, the method comprises:
obtaining performance parameters of the terminal device;
adding the performance parameters of the terminal device to the configuration parameter request information, so that the server obtains the target configuration parameters based on the performance parameters.

As an optional implementation of the embodiment of the present application, before sending the configuration parameter request information to the server, the method further comprises:
obtaining a target material type, the target material type being a material type of the target material; and
adding the target material type to the configuration parameter request information, so that the server obtains the target configuration parameters based on the target material type.

As an optional implementation of the embodiment of the present application, after extracting features of the target material based on the target configuration parameters, the method further comprises:
obtaining a time-consuming length taken to perform the feature extraction on the target material based on the target configuration parameters; and
sending the time-consuming length to the server.

In a second aspect, an embodiment of the present application provides a method for extracting feature information, comprising:
receiving configuration parameter request information sent by a terminal device, the configuration parameter request information being used to request configuration parameters for performing feature extraction on material;
obtaining target configuration parameters corresponding to the configuration parameter request information; and
sending the target configuration parameters to the terminal device so that the terminal device performs the feature extraction on the material based on the target configuration parameters.

As an optional implementation of the embodiment of the present application, the configuration parameter request information carries the performance parameters of the terminal device; and obtaining the target configuration parameters comprises:
obtaining the target configuration parameters based on the performance parameters.

As an optional implementation of the embodiment of the present application, obtaining the target configuration parameters based on the performance parameters comprises:
obtaining a performance score corresponding to the performance parameters based on a preset scoring algorithm; and
obtaining the target configuration parameters based on the performance score and a preset corresponding relationship;
wherein, the preset corresponding relationship comprises configuration parameters corresponding to each performance scoring interval.

As an optional implementation of the embodiment of the present application, the configuration parameter request information carries the target material type; and obtaining the target configuration parameters comprises:
obtaining configuration parameters for performing feature extraction on the target material type of the material of as the target configuration parameters.

As an optional implementation of the embodiment of the present application, the method further comprises:
receiving a time-consuming length, sent by the terminal device, taken to perform the feature extraction based on the target configuration parameters; and
updating the target configuration parameters based on the time-consuming length.

In a third aspect, an embodiment of the present application provides a terminal device, comprising:
a user input unit, configured to receive a first operation input by a user to a terminal device, the first operation being used to trigger the terminal device to perform feature extraction on target material;
a sending unit, configured to send configuration parameter request information to a server in response to the first operation;
a receiving unit, configured to receive target configuration parameters sent by the server; and
a processing unit, configured to perform feature extraction on the target material based on the target configuration parameters to obtain feature information of the target material.

As an optional implementation of the embodiment of the present application, the sending unit is also configured to obtain the performance parameters of the terminal device before sending the configuration parameter request information to the server, and add the performance parameters of the terminal device to the configuration parameter request information, so that the server obtains the target configuration parameters based on the performance parameters.

As an optional implementation of the embodiment of the present application, the sending unit is further configured to obtain a target material type before sending the configuration parameter request information to the server, and add the target material type to the configuration parameter request information, so that the server obtains the target configuration parameters based on the target material type;
wherein, the target material type is the material type of the target material;

As an optional implementation of the embodiment of the present application,
the processing unit is further configured to obtain a time-consuming length for performing feature extraction on the target material based on the target configuration parameters after performing feature extraction on the target material based on the target configuration parameters; and
the sending unit is further configured to send the time-consuming length to the server.

In a fourth aspect, an embodiment of the present application provides a server, comprising:
a receiving unit, configured to receive configuration parameter request information sent by a terminal device, the configuration parameter request information being used to request configuration parameters for performing feature extraction on material;
a processing unit, configured to obtain target configuration parameters corresponding to the configuration parameter request information; and
a sending unit, configured to send the target configuration parameters to the terminal device, so that the terminal device performs feature extraction on the material based on the target configuration parameters.

As an optional implementation of the embodiment of the present application, the configuration parameter request information carries the performance parameters of the terminal device;
the processing unit is specifically configured to obtain the target configuration parameters based on the performance parameters.

As an optional implementation of the embodiment of the present application, the processing unit is specifically configured to obtain the performance score corresponding to the performance parameters based on a preset scoring algorithm; and obtain the target configuration parameters based on the performance score and the preset corresponding relationship;
wherein, the preset corresponding relationship includes configuration parameters corresponding to each performance scoring interval.

As an optional implementation of the embodiment of the present application, the configuration parameter request information carries the target material type;
the processing unit is specifically configured to obtain configuration parameters for performing feature extraction on the target material type of the material as the target configuration parameters.

As an optional implementation of the embodiment of the present application,
the receiving unit is further configured to receive a time-consuming length, sent by the terminal device, taken to perform feature extraction based on the target configuration parameters;

The processing unit is further configured to update the target configuration parameters based on the time-consuming length.

In a fifth aspect, an embodiment of the present application provides an electronic device, comprising: a memory and a processor, wherein the memory is configured to store a computer program, and the processor is configured to enable the electronic device to implement the feature information extraction method described in any of the above embodiments when executing the computer program.

In a sixth aspect, an embodiment of the present application provides a computer-readable storage medium, when the computer program is executed by a computing device, enables the computing device to implement any of the above-mentioned feature information extraction methods.

In a seventh aspect, an embodiment of the present application provides a computer program product, which, when executed on a computer, enables the computer to implement any of the above-mentioned feature information extraction methods.

When receiving a first operation input by a user to a terminal device for triggering the terminal device to perform feature extraction on target material, the feature information extraction method provided in the embodiment of the present application first sends configuration parameter request information to a server in response to the first operation, and receives the target configuration parameters sent by the server, and then performs feature extraction on the target material based on the target configuration parameters to obtain feature information of the target material. Since the feature information extraction method provided in the embodiment of the present application can first obtain configuration parameters from a server when triggering feature extraction on material, and then perform feature extraction on the material based on the configuration parameters obtained from the server, when it is necessary to update the relevant configuration parameters for feature extraction, it is only necessary to update the configuration parameters stored in the server, and the updated configuration parameters can be applied to the terminal device without the need for application release, so the feature information extraction method provided in the embodiment of the present application can support flexible updates of configuration parameters for feature extraction on material.

### BRIEF DESCRIPTION OF THE DRAWINGS

The accompanying drawings, which are incorporated in and constitute a part of this specification, illustrate embodiments consistent with the present application and, together with the description, serve to explain the principles of the present application.

In order to more clearly illustrate the technical solutions in the embodiments of the present application or the prior art, the drawings required in the embodiments or the description of the prior art will be briefly introduced below. Obviously, for ordinary technicians in this field, other drawings can be obtained based on these drawings without paying any creative labor.

FIG. 1 is a scene structure diagram of a feature information extraction method provided in an embodiment of the present application;

FIG. 2 is one of the interactive flow charts of the feature information extraction method provided in an embodiment of the present application;

FIG. 3 is a second interactive flow chart of the feature information extraction method provided in an embodiment of the present application;

FIG. 4 is a third interactive flow chart of the feature information extraction method provided in an embodiment of the present application;

FIG. 5 is a fourth interactive flow chart of the feature information extraction method provided in an embodiment of the present application;

FIG. 6 is a schematic diagram of the structure of a terminal device provided in an embodiment of the present application;

FIG. 7 is a schematic diagram of the structure of a server provided in an embodiment of the present application;

FIG. 8 is a schematic diagram of the hardware structure of an electronic device provided in an embodiment of the present application.

### DETAILED DESCRIPTION OF EMBODIMENTS

The relevant configuration parameters of feature extraction of visual material by terminal devices are generally written in the application. If one wants to update the relevant configuration parameters of feature extraction, a new version of the application needs to be released. However, the release cycle of the application is generally long, so the relevant technology cannot flexibly update the relevant configuration parameters of feature extraction.

In order to more clearly understand the above-mentioned purposes, features and advantages of the present application, the scheme of the present application will be further described below. It should be noted that the embodiments of the present application and the features in the embodiments can be combined with each other without conflict.

In the following description, many specific details are set forth to facilitate a full understanding of the present application, but the present application may also be implemented in other ways different from those described herein. Obviously, the embodiments in the specification are only part of the embodiments of the present application, rather than all of the embodiments.

In the embodiments of the present application, words such as “exemplary” or “for example” are used to indicate examples, illustrations or descriptions. Any embodiment or design described as “exemplary” or “for example” in the embodiments of the present application should not be interpreted as being more preferred or more advantageous than other embodiments or designs. Specifically, the use of words such as “exemplary” or “for example” is intended to present related concepts in a concrete way. In addition, in the description of the embodiments of the present application, unless otherwise specified, the meaning of “multiple” refers to two or more.

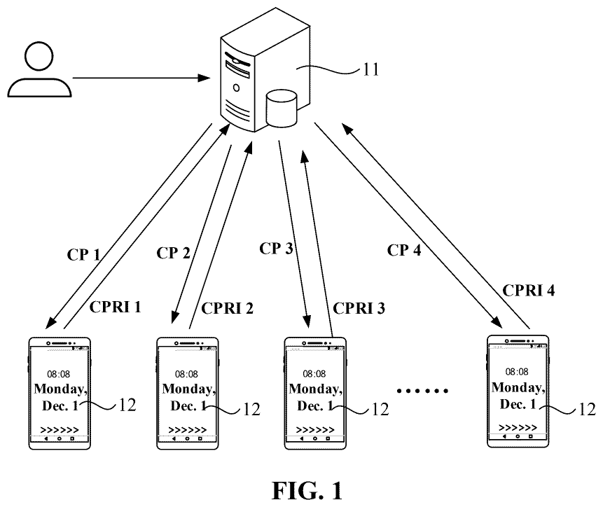

The following first describes the scenario architecture of the feature information extraction method provided in the embodiment of the present application. Referring to FIG. 1, in some embodiments, the scenario architecture of the feature information extraction method comprises: a server 11 and at least one terminal device 12 with which a communication link is established.

The server 11 stores configuration parameters for extracting features of the material. The configuration parameters stored in the server 11 can be set by the administrator and uploaded to the server 11. The terminal device 12 is installed with software for extracting features of the material. The software for extracting features of the material can be a sign extraction algorithm or a pre-trained machine learning model. When the terminal device 12 receives a request for extracting features of the material through the software, the terminal device 12 sends a configuration parameter request message for requesting configuration parameters to the server 11, receives the configuration parameters sent by the server 11, and extracts features of the material according to the configuration parameters sent by the server.

In some embodiments, the server 11 may only store one configuration parameter for extracting features of the material, and when receiving configuration parameter request information sent by the terminal device, the unique configuration parameter is directly sent to the terminal device.

In some embodiments, the server 11 may store configuration parameters for feature extraction of different material types of material, for example, the server 11 may store configuration parameters for feature extraction of images, configuration parameters for feature extraction of videos, configuration parameters for feature extraction of audio, configuration parameters for feature extraction of text, etc., respectively. When the terminal device 12 sends configuration parameter request information to the server 11, the material type is carried in the configuration parameter request information, and the server 11 sends the corresponding configuration parameters to the terminal device based on the material type carried in the configuration parameter request information.

In some embodiments, the server 11 may store configuration parameters for feature extraction of materials applicable to terminal devices with different performances. For example, the server 11 may store configuration parameters for feature extraction of material by high-performance terminal devices, configuration parameters for feature extraction of material by medium-performance terminal devices, and configuration parameters for feature extraction of materials by low-performance terminal devices, respectively. When the terminal device 12 sends configuration parameter request information to the server 11, the performance parameters of the terminal device are carried in the configuration parameter request information. The server 11 sends the configuration parameters applicable to the terminal device to the terminal device based on the performance parameters of the terminal device carried in the configuration parameter request information.

In some embodiments, the server 11 may store configuration parameters applicable to terminal devices with different performances for feature extraction of different material types of material. For example, the server 11 may store configuration parameters for feature extraction of images by high-performance terminal devices, configuration parameters for feature extraction of videos by high-performance terminal devices, configuration parameters for feature extraction of images by medium-performance terminal devices, and configuration parameters for feature extraction of videos by low-performance terminal devices. When the terminal device 12 sends configuration parameter request information to the server 11, the performance parameters of the terminal device and material types are carried in the configuration parameter request information. The server 11 sends the configuration parameters corresponding to the material types and applicable to the terminal device to the terminal device based on the performance parameters of the terminal device and material types carried in the configuration parameter request information.

The terminal device provided in the embodiment of the present application may be a mobile phone, a tablet computer, a laptop computer, a personal computer (PC), a netbook, a personal digital assistant (PDA), a smart watch, a smart bracelet, or other terminal devices, or the terminal device may also be other types of terminal devices, which is not limited in the embodiment of the present application.

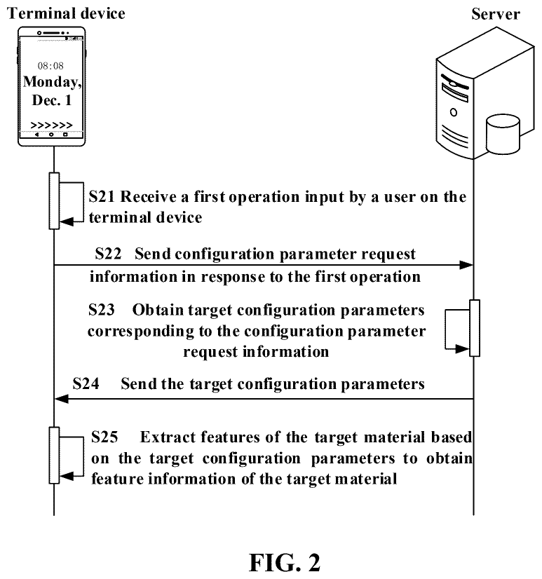

The embodiment of the invention provides a method for extracting feature information. As shown in FIG. 2, the method for extracting feature information comprises the following steps:
S21. The terminal device receives a first operation input by a user on the terminal device.

The first operation is used to trigger the terminal device to perform the feature extraction on the target material.

The type and form of the first operation are not limited in the embodiment of the present application, and the first operation can trigger the terminal device to perform the feature extraction on the target material. For example: in an image-based search scenario, a user operates an image displayed on a terminal device, thereby triggering the terminal device to extract feature information of the image and search based on the feature information of the image. In this case, the operation input by the user on the terminal device for the image is the first operation in the embodiment of the present application. Another example: in a video recommendation scenario, a user operates a video played on a terminal device, thereby triggering the terminal device to extract feature information of the video and recommend similar videos based on the feature information of the video. In this case, the operation input by the user on the terminal device for the video is also the first operation in the embodiment of the present application.

S22. The terminal device sends configuration parameter request information to the server in response to the first operation.

Correspondingly, the server receives configuration parameter request information sent by the terminal device, the configuration parameter request information is used to request configuration parameters for feature extraction of the material.

S23. The server obtains target configuration parameters corresponding to the configuration parameter request information.

In some embodiments, the server obtains the target configuration parameters corresponding to the configuration parameter request information, comprising: obtaining the configuration parameters corresponding to the configuration parameter request information from the saved configuration parameters to obtain the target configuration parameters.

Exemplarily, the target configuration parameters may include: resolution of the input image/video, blur radius of Gaussian blur, decoding method, sampling rate and other parameters.

S24. The server sends the target configuration parameters to the terminal device.

Correspondingly, the terminal device receives the target configuration parameters sent by the server.

S25. The terminal device extracts features of the target material based on the target configuration parameters to obtain feature information of the target material.

In some embodiments, the terminal device extracts features of the target material based on the target configuration parameters to obtain feature information of the target material, comprising: when the target material is an image, using one or more of computer vision algorithms such as image classification, target detection and image segmentation to perform feature extraction on the target material to obtain feature information of the target material.

In some embodiments, the terminal device performs feature extraction on the target material based on the target configuration parameters to obtain feature information of the target material, comprising: when the target material is a video, combining image processing and video analysis technology to extract key frames, motion features, scene transitions and other information as feature information of the target material.

When receiving a first operation input by a user to a terminal device for triggering the terminal device to perform feature extraction on target material, the feature information extraction method provided in the embodiment of the present application first sends configuration parameter request information to a server in response to the first operation, and receives the target configuration parameters sent by the server, and then performs feature extraction on the target material based on the target configuration parameters to obtain feature information of the target material. Since the feature information extraction method provided in the embodiment of the present application can first obtain configuration parameters from a server when triggering feature extraction on material, and then perform feature extraction on the material based on the configuration parameters obtained from the server, when it is necessary to update the relevant configuration parameters for feature extraction, it is only necessary to update the configuration parameters stored in the server, and the updated configuration parameters can be applied to the terminal device without the need for application release, so the feature information extraction method provided in the embodiment of the present application can support flexible updates of configuration parameters for feature extraction of the material.

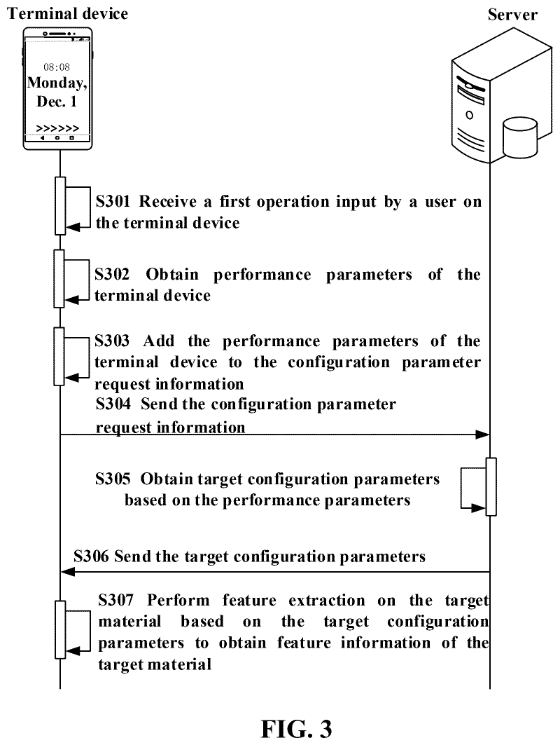

As an extension and refinement of the above embodiment, the embodiment of the present application provides another feature information extraction method. As shown in FIG. 3, the feature information extraction method comprises the following steps:

S301. A terminal device receives a first operation input by a user on the terminal device.

The first operation is used to trigger the terminal device to perform feature extraction on the target material.

S302. The terminal device obtains performance parameters of the terminal device.

In some embodiments, the performance parameters of the terminal device may include: performance parameters of a central processing unit (CPU), performance parameters of a graphics processing unit (GPU), performance parameters of memory I/O (Input/Output), and performance parameters of video soft decoding.

In some embodiments, the performance parameters of the CPU may include: the number of times the CPU can complete image recognition on an image with a specified resolution within a unit of time.

In some embodiments, the performance parameters of the GPU may include: the number of times the GPU can complete Gaussian blur on an image with a specified resolution within a unit of time.

In some embodiments, the performance parameters of the memory I/O may include: the number of times the memory I/O can copy an image of a specified resolution within a unit time.

In some embodiments, the performance parameters of the video soft decoding includes: the amount of data decoded for a video file with a specified resolution within a unit time.

S303. The terminal device adds the performance parameters of the terminal device to the configuration parameter request information.

That is, the performance parameters of the terminal device are carried in the configuration parameter request information.

S304. The terminal device sends the configuration parameter request information to the server.

Correspondingly, the server receives the configuration parameter request information sent by the terminal device, and the configuration parameter request information carries the performance parameters of the terminal device.

S305. The server obtains target configuration parameters based on the performance parameters.

In some embodiments, the implementation method of the server obtaining the target configuration parameters based on the performance parameters comprises the following steps a and b:

Step a. A performance score corresponding to the performance parameter is obtained based on a preset scoring algorithm.

In some embodiments, the above step a (A performance score corresponding to the performance parameter is obtained based on a preset scoring algorithm) comprises the following steps a1 to a3:

Step a1. The natural logarithms of the performance parameters of each dimension are obtained, respectively.

That is, the natural logarithms of the performance parameters of each dimension are obtained by the following formula:

$$M = {log}_{e} X$$

Among them, X is a performance parameter of any dimension, Mis the natural logarithm of the performance parameterX, e and is a natural constant.

Step a2. Normalize the natural logarithms of the performance parameters of each dimension to the range of 0 to 10 to obtain the normalized values of the performance parameters of each dimension.

In some embodiments, the natural logarithm of the performance parameter of each dimension may be normalized to a range of 0 to 10 using the following formula:

$$R = \frac{M - {M}_{min}}{{M}_{max} - {M}_{min}} \times ( {N}_{max} - {N}_{min} ) + {N}_{min}$$

Among them, M is the natural logarithm of any performance parameter, Mₘᵢₙ is the minimum value of the natural logarithm of the performance parameter, Mₘₐₓ is the maximum value of the natural logarithm of the performance parameter, Nₘₐₓ is the maximum value of the normalized range, and Nₘᵢₙ is the minimum value of the normalized range.

Step a3. Calculate the average value of the normalized values of the performance parameters of each dimension to obtain the performance score corresponding to the performance parameters.

In some embodiments, the average value of the normalized values of the performance parameters of each dimension may be calculated by the following formula:

$${R}^{′} = ( {\sum }_{i = 1}^{N} {R}_{i} ) / N$$

Among them, R′ is the average value of the normalized values of the performance parameters of each dimension, Rᵢ is the normalized value of the performance parameter of the i-th dimension, and N is the total number of dimensions of the performance parameters.

As described in the above example, the performance parameters of the terminal device include: the performance parameters of the central processing unit (CPU), the performance parameters of the graphics processing unit (GPU), the performance parameters of the memory I/O (Input/Output) and the performance parameters of the video soft decoding. The calculation formula of the performance score corresponding to the performance parameters is as follows:

$${R}^{′} = \frac{{R}_{CPU} + {R}_{GPU} + {R}_{IO} + {R}_{V}}{4}$$

Among them, R_{CPU} is the normalized value corresponding to the performance parameter of the CPU, R_{GPU} is the normalized value corresponding to the performance parameter of the GPU, R_{IO} is the normalized value corresponding to the performance parameter of the memory I/O, and R_{V} is the normalized value corresponding to the performance parameter of the video soft decoding.

Step b. The target configuration parameters are obtained based on the performance score and the preset corresponding relationship.

Among them, the preset corresponding relationship includes configuration parameters corresponding to each performance scoring interval.

Exemplarily, the preset corresponding relationship may be shown in the following Table 1:

TABLE 1

| performance score | configuration parameter |
|---|---|
| [0, 1) | configuration parameter 1 |
| [1, 2) | configuration parameter 2 |
| [2, 3) | configuration parameter 3 |
| [3, 4) | configuration parameter 4 |
| [4, 5) | configuration parameter 5 |
| [5, 6) | configuration parameter 6 |
| [6, 7) | configuration parameter 7 |
| [7, 8) | configuration parameter 8 |
| [8, 9) | configuration parameter 9 |
| [9, 10) | configuration parameter 10 |

When the preset corresponding relationship is as shown in Table 1 above, and the performance score is 5.6, configuration parameter 6 is used as the target configuration parameter.

S306. The server sends the target configuration parameters to the terminal device.

Correspondingly, the terminal device receives the target configuration parameters sent by the server.

S307. The terminal device performs feature extraction on the target material based on the target configuration parameters to obtain feature information of the target material.

In the feature information extraction method provided in the above embodiment, the terminal device can obtain the performance parameters of the terminal device and add the performance parameters of the terminal device to the configuration parameter request information. The server can obtain the performance score corresponding to the performance parameter according to a preset scoring algorithm, and obtain the target configuration parameters according to the performance score and the preset corresponding relationship. Therefore, the terminal device can extract features of the target material based on the configuration parameters that match its own performance, thereby avoiding excessive delay or jamming of feature extraction due to insufficient performance of the terminal device.

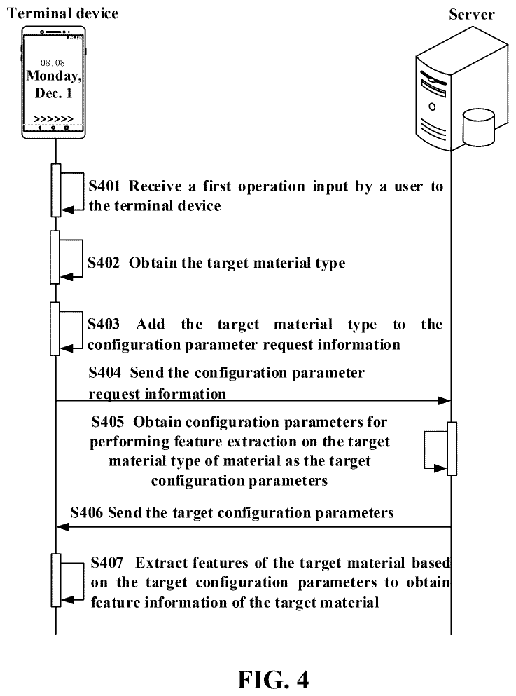

As an extension and refinement of the above embodiment, the embodiment of the present application provides another feature information extraction method. As shown in FIG. 4, the feature information extraction method comprises the following steps:

S401. The terminal device receives a first operation input by a user to the terminal device.

Among them, the first operation is used to trigger the terminal device to perform feature extraction on the target material.

S402. The terminal device obtains the target material type.

Among them, the target material type is the material type of the target material.

In some embodiments, the target material type may be at least one of video, image, audio, and text.

S403. The terminal device adds the target material type to the configuration parameter request information.

That is, one or more material types are carried in the configuration parameter request information.

S404. The terminal device sends the configuration parameter request information to the server.

Correspondingly, the server receives the configuration parameter request information sent by the terminal device, and the configuration parameter request information carries the target material type.

S405. The server obtains configuration parameters for performing feature extraction on the target material type of material as the target configuration parameters.

In some embodiments, the implementation method by which the server obtains the configuration parameters for feature extraction of the target material type of material as the target configuration parameters may include: obtaining the configuration parameters corresponding to the target material type as the target configuration parameters according to the corresponding relationship between the material type and the configuration parameters.

Exemplarily, the corresponding relationship between material types and configuration parameters may be shown in Table 2 below:

TABLE 2

| material type | configuration parameters |
|---|---|
| video | configuration parameter A |
| image | configuration parameter B |
| audio | configuration parameter C |
| text | configuration parameter D |
| three-dimensional | configuration parameter E |
| model | |
| . . . | . . . |

Exemplarily, when the corresponding relationship between the material types and the configuration parameters is as shown in 2 above, and the target material is an image, the configuration parameter B is obtained as the target configuration parameter.

S406. The server sends the target configuration parameters to the terminal device.

Correspondingly, the terminal device receives the target configuration parameters sent by the server.

S407. The terminal device extracts features of the target material based on the target configuration parameters to obtain feature information of the target material.

In the feature information extraction method provided in the above embodiment, the terminal device can obtain the material type of the material (target material) that needs feature extraction, and add the material type to the configuration parameter request information. The server can obtain the configuration parameters for feature extraction of the target material type of material as the target configuration parameters. Therefore, the server can only send the configuration parameters that the terminal device needs to use to the terminal device, without sending the configuration parameters for feature extraction of other types of materials to the terminal device, thereby reducing the amount of data of the configuration parameters that need to be transmitted.

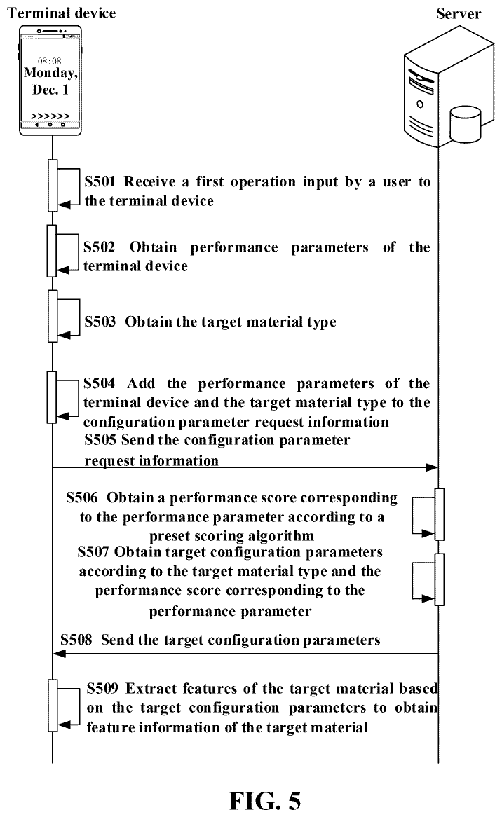

As an extension and refinement of the above embodiment, the embodiment of the present application provides another feature information extraction method. As shown in FIG. 5, the feature information extraction method comprises the following steps:
S501. A terminal device receives a first operation input by a user to the terminal device.

Among them, the first operation is used to trigger the terminal device to perform feature extraction on the target material.
S502. The terminal device obtains performance parameters of the terminal device.
S503. The terminal device obtains the target material type.

Among them, the target material type is the material type of the target material.
S504. The terminal device adds the performance parameters of the terminal device and the target material type to the configuration parameter request information.
S505. The terminal device sends the configuration parameter request information to the server.

Correspondingly, the server receives the configuration parameter request information sent by the terminal device, and the configuration parameter request information carries the performance parameters of the terminal device and the target material type.
S506. The server obtains a performance score corresponding to the performance parameter according to a preset scoring algorithm.

The implementation of the above step S506 can refer to the above step a, and to avoid redundancy, it will not be described in detail here.
S507. The server obtains target configuration parameters according to the target material type and the performance score corresponding to the performance parameter.

In some embodiments, the above step S507 (the server obtains the target configuration parameter according to the target material type and the performance score corresponding to the performance parameter) comprises the following steps 1 and 2:

Steps 1. A target configuration parameter set is obtained according to the target material type.

Among them, the target configuration parameter set is a set of configuration parameters corresponding to each performance score range and used for extracting features from the target material type of the material.

Step 2. Select the target configuration parameter from the target configuration parameter set according to the performance score corresponding to the performance parameter.

For example, the corresponding relationship between the material type, performance score and configuration parameter may be shown in the following Table 3:

TABLE 3

| material type | performance score | configuration parameters |
|---|---|---|
| video | [0, 1) | configuration parameter A1 |
| | [1, 2) | configuration parameter A2 |
| | [2, 3) | configuration parameter A3 |
| | [3, 4) | configuration parameter A4 |
| | [4, 5) | configuration parameter A5 |
| | [5, 6) | configuration parameter A6 |
| | [6, 7) | configuration parameter A7 |
| | [7, 8) | configuration parameter A8 |
| | [8, 9) | configuration parameter A9 |
| | [9, 10) | configuration parameter A10 |
| image | [0, 1) | configuration parameter B1 |
| | [1, 2) | configuration parameter B2 |
| | [2, 3) | configuration parameter B3 |
| | [3, 4) | configuration parameter B4 |
| | [4, 5) | configuration parameter B5 |
| | [5, 6) | configuration parameter B6 |
| | [6, 7) | configuration parameter B7 |
| | [7, 8) | configuration parameter B8 |
| | [8, 9) | configuration parameter B9 |
| | [9, 10) | configuration parameter B10 |
| . . . | . . . | . . . |

When the corresponding relationship between the material type, performance score and configuration parameters is as shown in Table 3 above, and the material type of the target material is video and the performance score of the terminal device is 7.3, firstly, the target configuration parameter set {configuration parameter A1, configuration parameter A2, configuration parameter A3, configuration parameter A4, configuration parameter A5, configuration parameter A6, configuration parameter A7, configuration parameter A8, configuration parameter A9, configuration parameter A10} can be selected according to the material type, and then configuration parameter A8 can be selected from the target configuration parameter set as the target configuration parameter according to the performance score of 7.3.
S508. The server sends the target configuration parameters to the terminal device.

Correspondingly, the terminal device receives the target configuration parameters sent by the server.
S509. The terminal device extracts features of the target material based on the target configuration parameters to obtain feature information of the target material.

In the feature information extraction method provided in the above embodiment, the terminal device can obtain the performance parameters and the material type of the material (target material) that needs feature extraction, and add the performance parameters and the material type of the target material to the configuration parameter request information. The server can obtain the target configuration parameters based on the material type and the performance information of the terminal device. Therefore, the above embodiment can reduce the amount of data of the configuration parameters that need to be transmitted, while enabling the terminal device to extract features of the target material based on the configuration parameters that match its own performance.

In some embodiments, based on any of the above embodiments, the feature information extraction method also comprises: the terminal device obtains a time-consuming length for feature extraction of the target material based on the target configuration parameters, and sends the time-consuming length to the server; the method is also used to receive the time-consuming length for feature extraction based on the target configuration parameters sent by the terminal device, and update the target configuration parameters based on the time-consuming length.

In some embodiments, the target configuration parameter is updated based on the time-consuming length, comprising: determining whether the time-consuming length is within a preset range; if the time-consuming length is less than the minimum value of the preset range, the target configuration parameter can be updated in a direction with a longer time-consuming length but more extracted feature information; if the time-consuming length is greater than the maximum value of the preset range, the target configuration parameter can be updated in a direction with a shorter time-consuming length but less extracted feature information.

Based on the same inventive concept, as an implementation of the above method, the embodiment of the present application also provides a terminal device and a server. This embodiment corresponds to the aforementioned method embodiment. For ease of reading, this embodiment will no longer repeat the details of the aforementioned method embodiment one by one, but it should be clear that the terminal device and server in this embodiment can correspondingly implement all the contents in the aforementioned method embodiment.

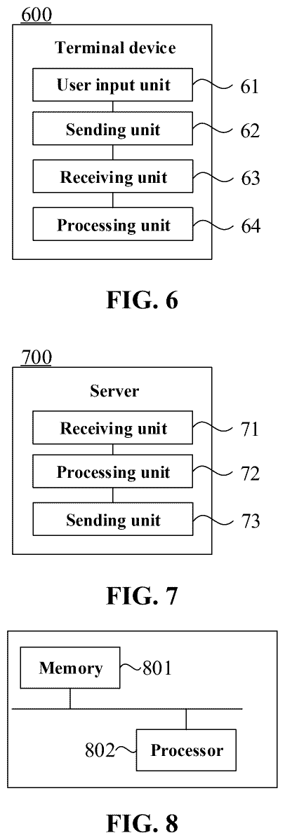

The embodiment of the present application provides a terminal device, and FIG. 6 is a schematic diagram of the structure of the terminal device. As shown in FIG. 6, the terminal device 600 comprises:
A user input unit 61, configured to receive a first operation input by a user to a terminal device, wherein the first operation is configured to trigger the terminal device to perform feature extraction on target material;
A sending unit 62, configured to send configuration parameter request information to a server in response to the first operation;
A receiving unit 63, configured to receive target configuration parameters sent by the server;
A processing unit 64, configured to perform feature extraction on the target material based on the target configuration parameters to obtain feature information of the target material.

As an optional implementation of the embodiment of the present application, the sending unit 62 is also configured to obtain the performance parameters of the terminal device before sending the configuration parameter request information to the server, and add the performance parameters of the terminal device to the configuration parameter request information, so that the server obtains the target configuration parameters according to the performance parameters.

As an optional implementation of the embodiment of the present application, the sending unit 62 is further configured to obtain a target material type before sending the configuration parameter request information to the server, and add the target material type to the configuration parameter request information, so that the server obtains the target configuration parameters according to the target material type;

Wherein, the target material type is the material type of the target material;

As an optional implementation of the embodiment of the present application,

The processing unit 64 is further configured to obtain a time-consuming length for performing feature extraction on the target material based on the target configuration parameters after performing feature extraction on the target material based on the target configuration parameters;

The sending unit 62 is further configured to send the time-consuming length to the server.

Some embodiments of the present application further provide a server. FIG. 7 is a schematic diagram of the structure of the server. As shown in FIG. 7, the server 700 comprises:
The receiving unit 71, configured to receive configuration parameter request information sent by the terminal device, the configuration parameter request information is used to request configuration parameters for feature extraction of the material;
A processing unit 72, configured to obtain a target configuration parameter corresponding to the configuration parameter request information;
The sending unit 73, configured to send the target configuration parameters to the terminal device, so that the terminal device perform feature extraction on the material according to the target configuration parameters.

As an optional implementation of the embodiment of the present application, the configuration parameter request information carries the performance parameters of the terminal device;

The processing unit 72 is specifically configured to obtain the target configuration parameters based on the performance parameters.

As an optional implementation of the embodiment of the present application, the processing unit 72 is specifically configured to obtain a performance score corresponding to the performance parameter based on a preset scoring algorithm; and obtain the target configuration parameters based on the performance score and a preset corresponding relationship;

Among them, the preset corresponding relationship includes configuration parameters corresponding to each performance scoring interval.

As an optional implementation of the embodiment of the present application, the configuration parameter request information carries the target material type;

The processing unit 72 is specifically configured to obtain configuration parameters for extracting features from the target material type of the material as the target configuration parameters.

As an optional implementation of the embodiment of the present application,

The receiving unit 71 is further configured to receive a time-consuming length for performing feature extraction based on the target configuration parameters, sent by the terminal device;

The processing unit 72 is further configured to update the target configuration parameters based on the time-consuming length.

The terminal device and the server provided in the embodiments of the present application can execute the feature information extraction method provided in any of the above embodiments. The implementation principles and technical effects are similar and will not be repeated here.

Based on the same inventive concept, an embodiment of the present application further provides an electronic device. FIG. 8 is a schematic diagram of the structure of an electronic device provided in an embodiment of the present application. As shown in FIG. 8, the electronic device provided in this embodiment comprises: a memory 801 and a processor 802, wherein the memory 801 is configured to store a computer program, and the processor 802 is configured to execute any feature information extraction method provided in the above embodiments when executing the computer program.

Based on the same inventive concept, an embodiment of the present application also provides a computer-readable storage medium, on which a computer program is stored. The computer program, when executed by a processor, causes the computing device to implement any feature information extraction method provided in the above embodiments.

Based on the same inventive concept, an embodiment of the present application further provides a computer program product. When the computer program product is run on a computer, the computing device implements any feature information extraction method provided in the above embodiments.

Those skilled in the art will appreciate that the embodiments of the present application may be provided as methods, systems, or computer program products. Therefore, the present application may adopt the form of a complete hardware embodiment, a complete software embodiment, or an embodiment combining software and hardware. Moreover, the present application may adopt the form of a computer program product implemented on one or more computer-usable storage media that include computer-usable program code.

The processor may be a central processing unit (CPU), other general-purpose processors, digital signal processors (DSP), application-specific integrated circuits (ASIC), field-programmable gate arrays (FPGA) or other programmable logic devices, discrete gate or transistor logic devices, discrete hardware components, etc. A general-purpose processor may be a microprocessor or any conventional processor, etc.

The memory may include the form of non-permanent memory in a computer-readable medium, random access memory (RAM) and/or non-volatile memory, etc., such as read-only memory (ROM) or flash RAM. The memory is an example of a computer-readable medium.

Computer readable media include permanent and non-permanent, removable and non-removable storage media. Storage media can be implemented by any method or technology to store information, and the information can be computer-readable instructions, data structures, program modules or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital versatile disk (DVD) or other optical storage, magnetic cassettes, magnetic disk storage or other magnetic storage devices or any other non-transmission media that can be used to store information that can be accessed by a computing device. As defined in this article, computer readable media does not include temporary computer readable media (transitory media), such as modulated data signal and carrier wave.

Finally, it should be noted that the above embodiments are only used to illustrate the technical solutions of the present application, rather than to limit it. Although the present application has been described in detail with reference to the aforementioned embodiments, those skilled in the art should understand that they can still modify the technical solutions described in the aforementioned embodiments, or make equivalent replacements for some or all of the technical features therein, and these modifications or replacements do not cause the essence of the corresponding technical solutions to deviate from the scope of the technical solutions of the embodiments of the present application.

I/We claim:

1. A method for extracting feature information, comprising:
receiving a first operation input by a user to a terminal device, wherein the first operation is used to trigger the terminal device to perform feature extraction on material;
in response to the first operation, transmitting a configuration parameter request to a server;
receiving a configuration parameter transmitted by the server; and
performing the feature extraction on the material based on the configuration parameter to obtain the feature information of the material.

2. The method according to claim 1, wherein before transmitting the configuration parameter request information to the server, the method comprises:
obtaining a performance parameter of the terminal device; and
adding the performance parameter of the terminal device to the configuration parameter request information, so that the server obtains the configuration parameter based on the performance parameter.

3. The method according to claim 1, wherein before transmitting the configuration parameter request information to the server, the method further comprises:
obtaining a material type, the material type is a material type of the material; and
adding the material type to the configuration parameter request information, so that the server obtains the configuration parameter based on the material type.

4. The method according to claim 1, wherein after performing the feature extraction on the material based on the configuration parameter, the method further comprises:
obtaining a time-consuming length taken to perform the feature extraction on the material based on the configuration parameter; and
transmitting the time-consuming length to the server.

5. A method for extracting feature information, comprising:
receiving configuration parameter request information transmitted by a terminal device, wherein the configuration parameter request information is used to request a configuration parameter for performing feature extraction on material;
obtaining configuration parameter corresponding to the configuration parameter request information; and
transmitting the configuration parameter to the terminal device, so that the terminal device performs the feature extraction on the material based on the configuration parameter.

6. The method according to claim 5, wherein the configuration parameter request information carries a performance parameter of the terminal device; and obtaining the configuration parameter comprises:
obtaining the configuration parameter based on the performance parameter.

7. The method according to claim 6, wherein obtaining the configuration parameter based on the performance parameter comprises:
obtaining a performance score corresponding to the performance parameter based on a preset scoring algorithm;
obtaining the configuration parameter based on the performance score and a preset corresponding relationship;
wherein the preset corresponding relationship includes a configuration parameter corresponding to each performance scoring interval.

8. The method according to claim 5, wherein the configuration parameter request information carries a material type; and obtaining the configuration parameter comprises:
obtaining a configuration parameter for performing the feature extraction on the material type of material as the configuration parameter.

9. The method according to claim 5, wherein the method further comprises:
receiving a time-consuming length, transmitted by the terminal device, taken to perform the feature extraction based on the configuration parameter; and
updating the configuration parameter based on the time-consuming length.

10. The method according to claim 6, wherein the performance parameter of the terminal device comprises: a performance parameter of a central processing unit, a performance parameter of a graphics processing unit, a performance parameter of memory Input/Output, and a performance parameter of video soft decoding.

11. The method according to claim 7, wherein obtaining a performance score corresponding to the performance parameter based on a preset scoring algorithm comprises:
obtaining a natural logarithm of a performance parameter of each dimension;
obtaining the normalized value of the performance parameter of each dimension; and
obtaining the performance score corresponding to the performance parameters by determining the average value of the normalized value of the performance parameter of each dimension.

12. The method according to claim 8, wherein obtaining a configuration parameter for performing the feature extraction on the material type of material as the configuration parameter comprises:
obtaining the configuration parameters corresponding to the material type as the configuration parameters according to the corresponding relationship between the material type and the configuration parameters.

13. An electronic device, comprises: a memory and a processor, wherein the memory is configured to store a computer program, the computer program, when executed by the processor, causes the electronic device to:
receive configuration parameter request information transmitted by a terminal device, wherein the configuration parameter request information is used to request a configuration parameter for performing feature extraction on material;
obtain configuration parameter corresponding to the configuration parameter request information; and
transmit the configuration parameter to the terminal device, so that the terminal device performs the feature extraction on the material based on the configuration parameter.

14. The electronic device of claim 13, wherein the configuration parameter request information carries a performance parameter of the terminal device; and the computer program causing the electronic device to obtain the configuration parameter comprises the instructions to:
obtain the configuration parameter based on the performance parameter.

15. The electronic device of claim 14, wherein the computer program causing the electronic device to obtain the configuration parameter based on the performance parameter comprises the instructions to:
obtain a performance score corresponding to the performance parameter based on a preset scoring algorithm;
obtain the configuration parameter based on the performance score and a preset corresponding relationship;
wherein the preset corresponding relationship includes a configuration parameter corresponding to each performance scoring interval.

16. The electronic device of claim 13, wherein the configuration parameter request information carries a material type; and the computer program causing the electronic device to obtain the configuration parameter comprises the instructions to:
obtain a configuration parameter for performing the feature extraction on the material type of material as the configuration parameter.

17. The electronic device of claim 13, wherein the computer program further comprises the instructions to:
receive a time-consuming length, transmitted by the terminal device, taken to perform the feature extraction based on the configuration parameter; and
update the configuration parameter based on the time-consuming length.

18. The electronic device of claim 14, wherein the performance parameter of the terminal device comprises: a performance parameter of a central processing unit, a performance parameter of a graphics processing unit, a performance parameter of memory Input/Output, and a performance parameter of video soft decoding.

19. The electronic device of claim 15, wherein the computer program causing the electronic device to obtain a performance score corresponding to the performance parameter based on a preset scoring algorithm comprises the instructions to:
obtain a natural logarithm of a performance parameter of each dimension;
obtain the normalized value of the performance parameter of each dimension; and
obtain the performance score corresponding to the performance parameters by determining the average value of the normalized value of the performance parameter of each dimension.

20. The electronic device of claim 16, wherein the computer program causing the electronic device to obtain a configuration parameter for performing the feature extraction on the material type of material as the configuration parameter comprises the instructions to:
obtain the configuration parameters corresponding to the material type as the configuration parameters according to the corresponding relationship between the material type and the configuration parameters.
